(19) United States
(12) Patent Application Publication
(10) Pub. No.: US 2015/0260389 A1
(43) Pub. Date: Sep. 17, 2015

(54) LIGHTING SYSTEM

(71) Applicant: Daniel Caron, Mirabel (CA)

(72) Inventor: Daniel Caron, Mirabel (CA)

(21) Appl. No.: 14/657,435

(22) Filed: Mar. 13, 2015

Related U.S. Application Data
(60) Provisional application No. 61/954,249, filed on Mar. 17, 2014.

(51) Int. Cl. F21V 29/74; F21S 8/04; F21S 4/00; F21V 21/02

(52) U.S. Cl. CPC F21V 29/74; F21V 21/025; F21S 8/043; F21S 4/003; F21Y 2103/003

(57) ABSTRACT

A lighting system including a substantially elongated and thermally conductive system body, the system body defining a system body outer surface, the system body outer surface defining at least two outer surface mounting sections, each of the at least two outer surface mounting sections extending substantially longitudinally along the system body at different circumferential locations therearound; a LED strip including a substantially elongated strip body defining strip body back and front surfaces and a plurality of LEDs mounted to the strip body front surface; and a substantially elongated heat sink, the heat sink defining a heat sink back surface and a substantially opposed heat sink front surface. The LED strip and the heat sink are each alternatively mountable to any one of the at least two outer surface mounting sections with the strip body back surface and the heat sink back surface abutting against the outer surface mounting sections.

### FIELD OF THE INVENTION

The present invention relates generally to light fixtures and, more particularly, to a lighting system usable for example to assemble a valance light fixture.

### BACKGROUND

Valance light fixtures are known in the art and are used to add accent or ambiance lighting behind a curtain headrail, around the periphery of ceilings, on top surface portions of kitchen cabinets, and the likes.

Valance light fixtures of the prior art generally take the form of elongated neon light fixtures or elongated light strip fixtures comprising solid state, light emitting diodes (LEDs).

The typically elongated housing of the valance light fixtures is generally directly fixed to a support structure, such as a wall portion, a windowsill, or the like, using conventional fastening means such as screws, nails, construction grade staples, or the like. Thus, once a valance light fixture is fastened to a support structure, it is generally not easily removed for maintenance reasons such as, for examples, a thorough cleaning, a repair or a replacement procedure, without using hand tools.

The valance light fixtures of the prior art generally emit light in a fixed direction that is not easily customizable. For examples, they generally either emit light along one, two or three longitudinal sides. Thus, to satisfy varied decorative needs of end clients, the factories or home hardware stores have to keep a large inventory of valance light fixtures that are emitting light in various directions.

Furthermore, valance light fixtures of the prior art made of LED light strips that generally emit light in a single fixed color that is not easily customizable, unless the valance light is equipped with more expensive light strips comprising LED's of various colors that are controlled by custom electronic control circuits.

Yet furthermore, power dissipation needs of prior art valence light fixtures depend on the power of the LEDs emitting light. If a model line of valence light fixtures includes LED modules of different power, there is a need to either manufacture the main body of the valence light fixture with heat sinks able to dissipate the power of the highest power LED module, which requires the use of too much material if the lower power LED modules are used, or which require many models of the main body, which increases tooling, manufacturing and inventory costs.

In view of the above, there is a need in the industry for an improved lighting system.

An object of the present invention is to provide such a lighting system.

### SUMMARY OF THE INVENTION

In a broad aspect, the invention provides a lighting system, the lighting system comprising: a substantially elongated and thermally conductive system body, the system body defining a system body outer surface, the system body outer surface defining at least two outer surface mounting sections, each of the at least two outer surface mounting sections extending substantially longitudinally along the system body at different circumferential locations therearound; a light emitting diode (LED) strip including a substantially elongated strip body defining strip body back and front surfaces and a plurality of LEDs mounted to the strip body front surface; and a substantially elongated heat sink, the heat sink defining a heat sink back surface and a substantially opposed heat sink front surface. The LED strip and the heat sink are each alternatively mountable to any one of the at least two outer surface mounting sections with the strip body back surface and the heat sink back surface abutting against the outer surface mounting sections.

The invention may also provide a lighting system wherein the outer surface mounting sections each define a respective recess formed in the system body outer surface and extending substantially longitudinally along the system body.

The invention may also provide a lighting system wherein the recess defines a recess bottom surface, the recess bottom surfaces conforming to the strip body and heat sink back surfaces.

The invention may also provide a lighting system wherein the recess bottom surface, the strip body back surface and the heat sink back surface are each substantially planar.

The invention may also provide a lighting system wherein the recess has a substantially U-shaped tranversal cross-sectional configuration.

The invention may also provide a lighting system wherein the system body has a substantially polygonal transversal cross-sectional configuration.

The invention may also provide a lighting system wherein the system body has a substantially square transversal cross-sectional configuration.

The invention may also provide a lighting system wherein the system body outer surface defines at least three outer surface mounting sections, the at least two outer surface mounting sections being part of the at least three outer surface mounting sections, each of the at least three outer surface mounting sections extending substantially longitudinally along the system body at different circumferential locations therearound, the lighting system further comprising another LED strip mountable to any unoccupied one of the at least three outer surface mounting sections.

The invention may also provide a lighting system wherein the system body outer surface defines at least three outer surface mounting sections, the at least two outer surface mounting sections being part of the at least three outer surface mounting sections, each of the at least three outer surface mounting sections extending substantially longitudinally along the system body at different circumferential locations therearound, the lighting system further comprising another heat sink mountable to any unoccupied one of the at least three outer surface mounting sections.

The invention may also provide a lighting system wherein the system body is hollow and defines a system body passageway extending substantially longitudinally therethrough.

The invention may also provide a lighting system further comprising a mounting bracket, the mounting bracket defining a bracket coupling portion, the heat sink including at least one heat sink coupling portion spaced apart from the heat sink back surface, the heat sink and bracket coupling portions being selectively couplable to each other to secure the heat sink and the mounting bracket to each other.

The invention may also provide a lighting system wherein the heat sink coupling portion defines a mounting bracket engaging groove extending substantially longitudinally along the heat sink and into the heat sink from the heat sink front surface, the heat sink coupling portion also defining and a pair of groove lips each extending partially across the mounting bracket engaging groove substantially adjacent the heat sink front surface, the groove lips defining a substantially longitudinally extending groove gap across the heat sink front surface; and the bracket coupling portion defines a groove engaging portion insertable in the mounting bracket engaging groove and a neck extending from the groove engaging portion and positioned in the groove gap when the mounting bracket is operatively mounted to the heat sink with the groove engaging portion inserted in the mounting bracket engaging groove.

The invention may also provide a lighting system wherein the groove engaging portion is substantially snugly received in the mounting bracket engaging groove when the mounting bracket is operatively mounted to the heat sink with the groove engaging portion inserted in the mounting bracket engaging groove.

The invention may also provide a lighting system wherein the groove engaging portion is substantially resiliently deformable so that the groove engaging portion is deformed when compared to an undeformed configuration when operatively mounted to the heat sink with the groove engaging portion inserted in the mounting bracket engaging groove.

The invention may also provide a lighting system wherein the groove engaging portion is substantially C-shaped and opens substantially opposed the neck.

The invention may also provide a lighting system wherein the heat sink coupling portion defines at least two substantially parallel mounting bracket engaging grooves each extending substantially longitudinally along the heat sink and into the heat sink from the heat sink front surface, the heat sink coupling portion also defining and a pair of groove lips for each of the mounting bracket engaging grooves, each of the groove lips extending partially across one of the mounting bracket engaging grooves substantially adjacent the heat sink front surface, the pairs groove lips each defining a substantially longitudinally extending groove gap across the heat sink front surface in register with a respective one of the mounting bracket engaging grooves; and the bracket coupling portion defines a groove engaging portion selectively insertable in any one of the mounting bracket engaging grooves and a neck extending from the groove engaging portion and positioned in the groove gap in register with the one of the mounting bracket engaging grooves when the mounting bracket is operatively mounted to the heat sink with the groove engaging portion inserted in the one of the mounting bracket engaging grooves.

The invention may also provide a lighting system further comprising a heat sink-to-heat sink linking element, the heat sink-to-heat sink linking element defining a pair of substantially opposed linking element coupling portions each selectively couplable to the heat sink coupling portion of two different ones of the heat sinks for securing the two different ones of the heat sinks to each other.

The invention may also provide a lighting system wherein the heat sink-to-heat sink linking element includes a least one pair of stabilizing elements configured and sized for both abutting the heat sink front surface when operatively mounted to the heat sink so as to fix an orientation of the heat sink-to-heat sink linking element relative to the heat sink when operatively mounted thereto.

The invention may also provide a lighting system wherein the heat sink is provided with a series of heat sink bores extending between the heat sink front and back surfaces and longitudinally spaced apart from each other and the system body is provided with a series of system body bores extending between at least one of the outer surface mounting sections and the system body passageway, the system body and heat sink bores being pairwise in register with each other when the heat sink is operatively mounted top the system body, the lighting system further comprising at least one fastener securing the heat sink to the system body and extending through at least one of the system body bores and through the heat sink bore in register with the at least one of the system body bores.

The invention may also provide a lighting system wherein the system body defines system body ends substantially longitudinally opposed to each other, the lighting system further comprising a pair of end caps mountable to the system body substantially adjacent the system body ends.

The invention may also provide a lighting system wherein the heat sink front surface defines heat dissipating fins, the heat sink coupling portion being formed by the heat dissipating fins.

The invention may also provide a lighting system wherein the outer surface mounting sections are substantially identically shaped and sized.

Advantageously, the proposed lighting system is very flexible and may be assembled in many different configurations, relatively rapidly, using a relatively small amount of parts.

The present application claims benefit from U.S. provisional patent application 61/954,249 filed Mar. 17, 2014, the contents of which is hereby incorporated by reference in its entirety.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1 is a perspective view of a valance light fixture, according to the present invention;

FIG. 2A is a perspective view of an elongated housing member part of the valance light fixture shown in FIG. 1;

FIG. 2B is an end plan view of the elongated housing member of FIG. 2A;

FIG. 3 is an end plan view of the valance light fixture of FIG. 1, here shown having an end cap thereof removed;

FIG. 4 is an end plan view of an elongated channel member having a substantially U-shaped cross-section part of the valence light fixture of FIG. 1;

FIG. 5 is a distal end plan view of the elongated channel member of FIG. 4, here shown with three elongated light strips inserted longitudinally in a corresponding number of suitably shaped, elongated side grooves provided along the three outer longitudinal sides of the elongated channel member of FIG. 4;

FIG. 6 is a front plan view of a conventional light strip comprising a plurality of LED's;

FIG. 7 is a perspective view of the elongated channel member of FIG. 4, here shown having a portion of a light strip slidably inserted in one of the elongated side grooves thereof;

FIG. 8 is a perspective inner view of a first housing member end cap part of the valence light fixture of FIG. 1 and provided with an inner aperture for receiving the wire ends of an external power source;

FIG. 9 is a perspective inner view of a second housing member end cap part of the valence light fixture of FIG. 1;

FIG. 10 is an inner plan view of the first housing member end cap shown in FIG. 8;

FIG. 11 is a side plan view of the second housing member end cap shown in FIG. 9;

FIG. 12 is a side plan view of the first end cap in FIG. 8, here shown with a portion of a power cable having a suitably configured and shaped distal end inserted in the aperture provided therethrough;

FIG. 13 is an inner plan view of the second housing member end cap of FIG. 9;

FIG. 14 is a perspective view of a first mounting bracket part of the valence light fixture of FIG. 1;

FIG. 15 is a side plan view of the first mounting bracket of FIG. 14;

FIG. 16 is a front plan view of the first mounting bracket of FIG. 14;

FIG. 17 is perspective view of a second mounting bracket usable in the valence light fixture of FIG. 1;

FIG. 18 is a side plan view of the second mounting bracket of FIG. 17;

FIG. 19 is a perspective view of a third mounting bracket usable in the valence light fixture of FIG. 1;

FIG. 20 is top plan view of the third mounting bracket of FIG. 19;

FIG. 21 is a side plan view of the third mounting bracket of FIG. 19;

FIG. 22 is a front plan view of the third mounting bracket of FIG. 19;

FIG. 23 is a perspective view of a fourth mounting bracket usable in the valence light fixture of FIG. 1;

FIG. 24 is a side plan view of the fourth mounting bracket of FIG. 23;

FIG. 25 is an environmental, perspective view of the valance light fixture, of FIG. 1, here shown suspended to a curtain headrail;

FIG. 26 is an end plan view of a the valence light fixture of FIG. 1, with the mounting bracket thereof removed engaged with a ball chain element;

FIG. 27 is a perspective view of a conventional ball chain locking element usable with the ball chain element of FIG. 26;

FIG. 28 is a perspective view of an end support housing, here shown engaged on an end of an elongated channel member provided with elongated light strips;

FIG. 29A, in an end view illustrate an end support housing;

FIG. 29B, in a perspective view, illustrate the end support housing of FIG. 29A;

FIG. 29C, in an alternative perspective view, illustrate the end support housing of FIGS. 29A and 29B;

FIG. 30A, in an end plan view, illustrates illustrates an end cap;

FIG. 30B, in side plan view, illustrates illustrates the end cap of FIG. 30A;

FIG. 30C, in a perspective view, illustrates illustrates the end cap of FIGS. 30A and 30B;

FIG. 31A, in an end plan view, illustrates a channel member;

FIG. 31B, in a perspective view, illustrates the channel member of FIG. 31A;

FIG. 32, in a perspective exploded view, illustrates an end portion of an embodiment of a valance light fixture in accordance with an alternative embodiment of the present invention;

FIG. 33, in a perspective assembled view, illustrates the valance light fixture of FIG. 32;

FIG. 34A in an end plan view illustrates a channel member end cap;

FIG. 34B, in a side plan view, illustrates the channel member end cap of FIG. 34A;

FIG. 34C, in a perspective view, illustrates the channel member end cap of FIGS. 34A and 34B;

FIG. 35A, in an end plan view, illustrates a system body part of a lighting system in accordance with an embodiment of the present invention;

FIG. 35B, in a perspective view, illustrates the system body of FIG. 35A;

FIG. 36A, in an end plan view, illustrates a first type of heat sink of the lighting system;

FIG. 36B, in a perspective view, illustrates the heat sink of FIG. 36A;

FIG. 37A, in an end plan view, illustrates a second type of heat sink of the lighting system;

FIG. 37B, in a perspective view, illustrates the heat sink of FIG. 37A;

FIG. 38, in a perspective exploded partial view, illustrates the lighting system;

FIG. 39, in an end plan view, illustrates the lighting system of FIG. 38;

FIG. 40, in a perspective assembled view respectively, illustrates the lighting system of FIGS. 38 and 39;

FIG. 41A, in an end plan view, illustrates a mounting bracket part of the lighting system of FIGS. 38 to 40;

FIG. 41B, in a perspective view, illustrates the mounting bracket of FIG. 41A;

FIG. 42A, in an end plan view, illustrates a first embodiment of a heat sink-to-heat sink linking element usable with the lighting system of FIGS. 38 to 40;

FIG. 42B, in a perspective view, illustrates the heat sink-to-heat sink linking element of FIG. 42A;

FIG. 43A, in an end plan view, illustrates a second embodiment of a heat sink-to-heat sink linking element usable with the lighting system of FIGS. 38 to 40;

FIG. 43B, in a perspective view, illustrates the heat sink-to-heat sink linking element of FIG. 43A;

FIG. 44A, in an end plan view, illustrates a third embodiment of a heat sink-to-heat sink linking element usable with the lighting system of FIGS. 38 to 40;

FIG. 44B, in a perspective view, illustrates the heat sink-to-heat sink linking element of FIG. 44A;

FIG. 45, in an end plan view, illustrates two lighting systems of FIGS. 38 to 40 secured to each other using the heat sink-to-heat sink linking element of FIGS. 44A and 44B;

FIG. 46, in a perspective view, illustrates the two lighting systems of FIG. 45;

FIG. 47, in a top perspective view, illustrates a first type and a second type of heat sink attached to the system body of FIGS. 35A and 35B;

FIG. 48, in an end plan exploded view, illustrates the assembly of FIG. 47;

FIG. 49, in an end plan assembled view, illustrates the assembly of FIG. 47;

FIG. 50, in a perspective view, illustrates a distal end portion of an alternate embodiment of a lighting system; and

FIG. 51, in a side elevational exploded view, illustrates a parallel array assembly of lighting systems of FIG. 50 serially powered in a daisy chain fashion through a power bar and power supply.

### DETAILED DESCRIPTION

The term “substantially” is used throughout this document to indicate variations in the thus qualified terms. These variations are variations that do not materially affect the manner in which the invention works and can be due, for example, to uncertainty in manufacturing processes or to small deviations from a nominal value or ideal shape that do not cause significant changes to the invention. These variations are to be interpreted from the point of view of the person skilled in the art.

FIG. 1 shows various aspects of an embodiment of a valance light fixture 10 according to the present invention.

The valance light fixture 10 generally includes an elongated light emitting element 12, a power cable 14, for powering the light emitting element 12, and at least one mounting bracket 16, adapted for mounting the light emitting element 12 at a predetermined angle relative to a support structure such as, for examples, a wall surface, a windowsill, a top surface portion of a kitchen cabinet, a curtain pole, or the likes.

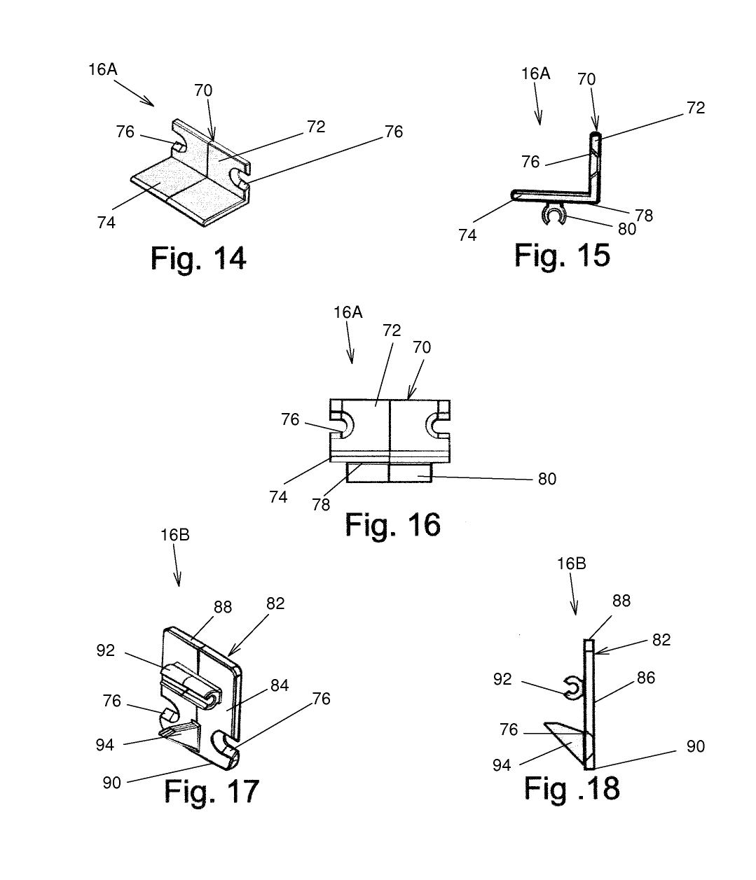

As it will be described in details further below, the valance light fixture 10 may be mounted to a support structure using at least one, but typically a plurality of mounting brackets 16. As best illustrated in FIGS. 14 to 24 inclusively, the valance light fixture 10 may be mounted to a support structure using one or a combination of mounting brackets selected among mounting brackets 16A, 16B, 16C, 16D, and 16E, which will be described further below.

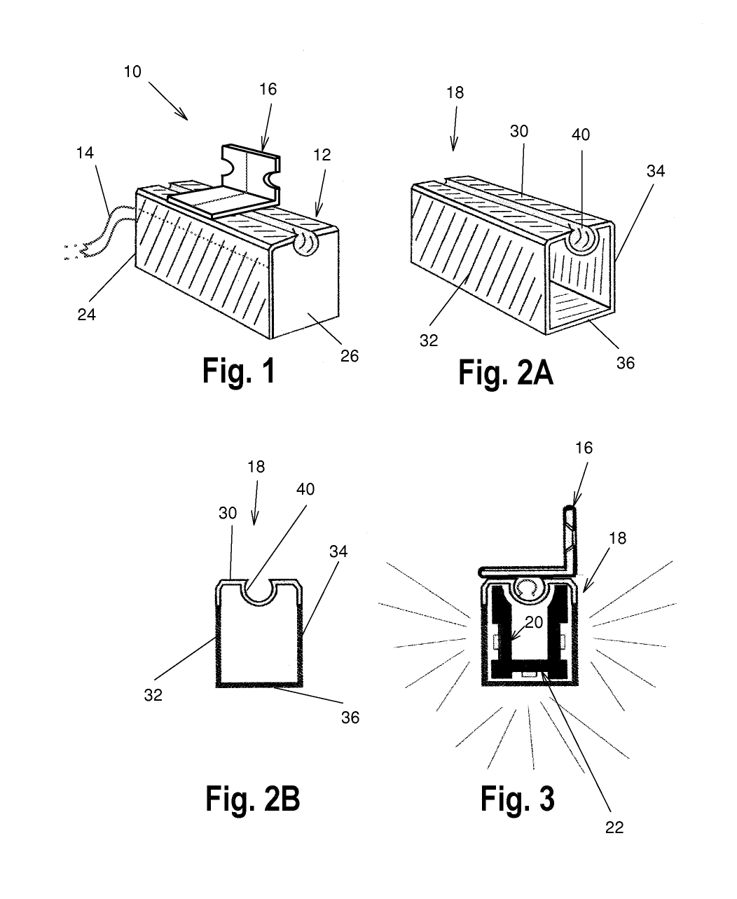

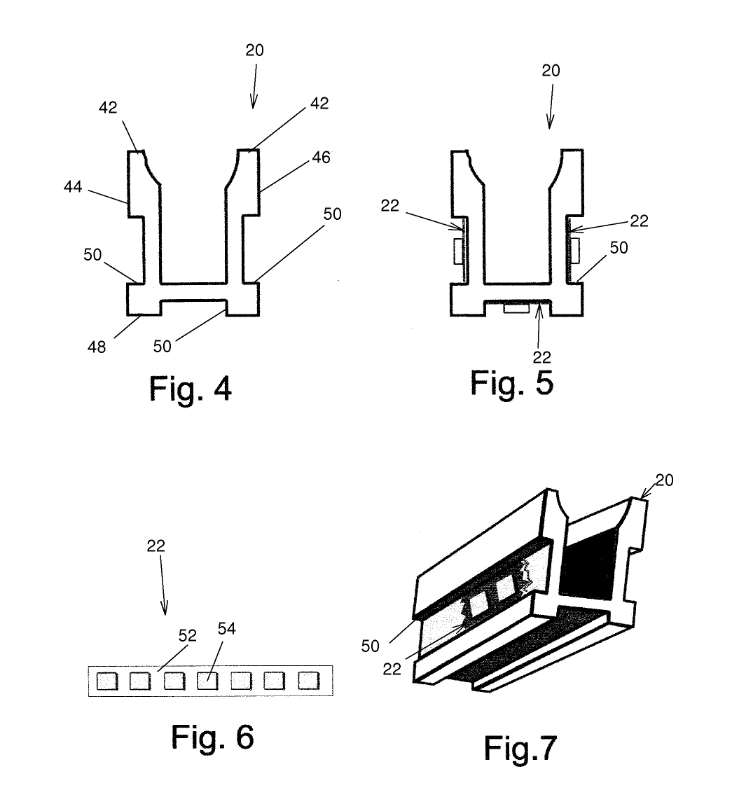

The light emitting element 12 is represented by an assembly that generally includes an elongated, tubular housing member 18, as best illustrated in FIGS. 2A and 2B, an elongated channel member 20 having a substantially U-shaped cross-section, as best illustrated in FIGS. 4, 5 and 7, and at least one, and up to three elongated LED strips 22, such as illustrated in FIGS. 5 and 6.

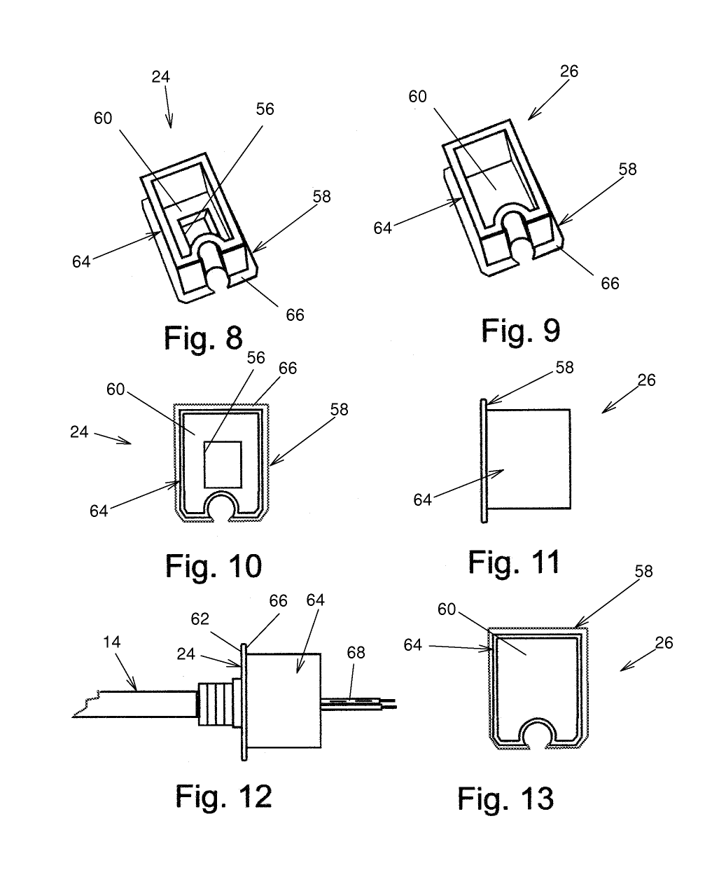

The light emitting element 12 further includes a first housing member end cap 24 provided with an inner aperture 26, as illustrated in FIGS. 8 and 10, and a second housing member end cap 28, as illustrated in FIGS. 9 and 13. As it will be described in details more below, in some embodiments, the light emitting element 12 may include two housing member end caps 24 having an inner aperture 26 instead of one housing member end cap 24 and one housing member end cap 28 as described above.

The light emitting element 12 still further includes a power cable 14 having a first distal end adapted to be inserted through the inner aperture 56 of a housing member end cap 24, as illustrated in FIG. 12, and its opposite distal end being provided with a suitable power supply unit (not shown) conventionally used for indoor lighting fixtures.

FIGS. 2A and 2B show a tubular and substantially elongated housing member 18 having a substantially square shaped cross-section. The square shaped cross-section of the housing member 18 defines a longitudinal mounting surface 30, a pair of oppositely disposed, longitudinal side surfaces 32 and 34, and a distal longitudinal surface 36 substantially opposed to the longitudinal mounting surface 30.

Substantially centered along the longitudinal mounting surface 30, there is provided a mounting bracket engaging groove 40 extending inwardly relative to the surface 30, and defining a groove therein having a substantially near-circular cross-section. The mounting bracket engaging groove 40 is adapted for resiliently engaging with a suitably shaped and configured mounting member of the mounting brackets 16A and 16B.

In some embodiments, the mounting bracket engaging groove 40 has a cross-sectional diameter that substantially corresponds to the diameter of a conventionally sized ball chain commonly used to manually operate curtainrail assemblies or the like. Thus, as it will be described in more details further below, a conventional ball chain may be used to suspend the light emitting element 12 to a curtainrail or any equivalent horizontal member.

Housing member 18 is for example represented by a single piece element made of a suitably rigid plastic material using a conventional extruding or injection molding process. As best illustrated in FIGS. 2B and 3, the mounting surface 30, including the mounting bracket engaging groove 40 and relatively small, adjacent portions of the longitudinal side surfaces 32, 34, are typically made of an opaque material, while the rest of the longitudinal side surfaces 32, 34 and the distal longitudinal surface 36 are made of a transparent, or at least a translucent material for allowing light to emit outwardly therethrough.

FIGS. 4, 5 and 7 show various aspects of an elongated channel member 20 having a substantially U-shaped cross-section.

The overall cross-sectional dimensions of the U-shaped channel member 20 are suitably sized and shaped such that the channel member 20 may be freely longitudinally inserted through an open end of the tubular housing member 18, with its free end edges 42 being in register with the longitudinal spaces along either sides of the protruding inner surface defining the mounting bracket engaging groove 40, as illustrated in FIG. 3.

Each of the three longitudinal outer surfaces 44, 46 and 48 of the U-shaped channel member 20 is provided with a light strip engaging groove 50 having a substantially rectangular cross-section. The light strip engaging grooves 50 are each suitably sized and shaped for freely slidably receiving therein the rear portion of an elongated LED strip 22, as illustrated in FIGS. 3, 5 and 7.

The elongated channel member 20 is typically made of a suitably rigid material whose rigidity is not significantly affected by the accumulated heat that may be generated by high intensity LED strips 22 inserted in a fully assembled and powered valance light fixture 10. For example, the U-shaped channel member 20 may be made of aluminum, a suitable metal alloy, a suitable polymer, glass, or a composite material, that is preferably light weight and rust proof.

Thus, the U-shaped channel member 20, which serves as a positioning element of the LED strips 22 within the housing member 18, also serves as a strengthening structure element of an assembled valance light fixture 10.

An elongated LED strip 22, as illustrated in FIG. 6, may be any conventional and commercially available LED strip element having a suitable shape and size for allowing the light strip to be freely slidably engaged along the light strip engaging grooves 50 of the U-shaped channel member 20.

A typical LED strip 22 of the prior art, as illustrated in a front plan view in FIG. 6, and shown in a perspective partial view in FIG. 7, is generally represented by a substantially elongated printed circuit board 52 having soldered on a front side a plurality of light emitting diodes 54, or LEDs, that are equidistantly disposed therealong.

FIGS. 8 to 13 inclusively show various aspects of a first end cap 24 (shown in FIGS. 8, 10 and 12) provided with an inner aperture 56, and a second housing member end cap 26 (shown in FIGS. 9, 11 and 13).

First end cap 24 may be represented by a single piece element having a plate member 58 defining an inner side 60 (seen in FIGS. 8 and 12) and an outer side 62 (better seen in FIG. 12), and whose outer shape and dimensions are substantially identical to the cross-sectional outer shape and dimensions of the elongated housing member 18, including the semi-circular groove portion of the latter. A relatively short tubular portion 64, having a substantially identical but relatively smaller cross-section as the plate member 58, here again, including the semi-circular groove portion, has a first end integrally formed substantially centrally on the inner side 60 of the plate member 58, and the opposite end extending perpendicularly therefrom. Thus, a relatively small abutting ledge 66 is formed about the periphery of the plate member 58.

Furthermore, the short tubular portion 64 has an outer cross-sectional shape and dimensions allowing the latter to be slidably inserted, in a snug fit relation, within an open end of the elongated housing member 18 until the protruding periphery, or abutting ledge 66 of the plate member 58 firmly abuts against the distal end thereof, thus forming an end cap to the housing member 18.

As best mentioned above, and illustrated in FIGS. 8, 10 and 12, the end cap 24 is provided with an inner aperture 56 for receiving therethrough a distal end of a power cable 14 whose end wires 68 may be typically soldered to electrical contact points (not shown) provided at a distal end of a LED strip 22 positioned inside the light emitting element 12.

Furthermore, a portion of the outer shielding, proximal the distal end of the power cable 14, is preferably suitably shaped and sized such that it may be resiliently engaged about the inner periphery of inner aperture 56 of the end cap 24, for providing a sufficient mechanical retention between the power cable 14 and the assembled light emitting element 12.

The second housing member end cap 26 is substantially identical to the first end cap 24 described above, except that it is not provided with an aperture. Housing member end cap 26 is mainly for the purpose of sealingly enclosing the distal end of an assembled U-shaped channel member 20 and LED strips 22 combination within the elongated housing member 18.

The end caps 24 and 26 are typically represented by single piece elements made of a suitably rigid plastic material using a conventional injection molding process.

The overall length of the U-shaped channel member 20 and the LED strip or strips 22 are typically substantially equal. An assembled U-shaped channel member 20 and LED strip 22 combination has a suitable overall length that is relatively shorter than the length of an elongated housing member 18, for allowing the channel member 20 and light strip 22 combination to be enclosed within the housing member 18, between the end caps 24 and 26.

Thus, an assembled elongated light emitting element 12 may include a U-shaped channel member 20, provided with at least one, and up to three LED strips 22, that is inserted in a housing member 18, with a power cable 14 and end cap 24 combination for closing a first distal end, and an end cap 26 for closing the opposite distal end thereof.

In an alternate preferred embodiment, the housing member end cap 26 may be replaced with an additional power cable 14 and end cap 24 combination, for allowing the connection in series of a plurality of light emitting elements 12 in a daisy chain configuration.

FIGS. 14 to 24 inclusively, show various aspects of differently shaped and configured mounting brackets, namely a first, second, third, fourth and fifth mounting bracket 16A, 16B, 16C, 16D and 16E respectively.

FIGS. 14, 15 and 16 inclusively, show the first mounting bracket 16A that is generally represented by a relatively short right angle member 70 defining a first mounting portion 72 and a second mounting portion 74.

The first mounting portion 72 is provided with suitable mounting means such as, for example, a plurality of mounting holes or lateral recesses 76, for rigidly fixing the mounting bracket 16A against a mounting surface portion of a support structure using for example flat-head screws, nails, or the like.

As better seen in FIG. 15, the second mounting portion 74 is provided, along its outer surface 78 thereof, with a mounting member 80 suitably shaped and sized for resiliently engaging the mounting bracket engaging groove 40 of the elongated housing member 18. The mounting member 80 is generally represented by a substantially cylindrically-shaped member having a C-shaped cross-section, and a longitudinal side portion, opposite the open side portion, that is integrally formed centrally longitudinally along the outer surface of the second mounting portion 74, as best illustrated in FIGS. 15 and 16.

The C-shaped cross-section of the mounting member 80 is suitably sized and shaped such that it exerts a sufficiently spring biased outward action against the inner cylindrical surface of the mounting bracket engaging groove 40 for resiliently retaining the mounting bracket 16A therein.

Thus, the first mounting bracket 16A may be used for rigidly fixing a light emitting element 12, as described above, to a mounting surface portion of a support structure such that the distal longitudinal surface 36 of the light emitting element 12 may be projecting light in a substantially parallel direction relative to the mounting surface portion.

FIGS. 17 and 18 show a second mounting bracket 16B that is generally represented by a mounting plate member 82 defining a front side surface 84 (better seen in FIG. 17), a rear side surface 86 (better seen in FIG. 18), an upper edge 88, and a lower edge 90. As seen in FIG. 17, the second mounting bracket 16B is provided with suitable mounting means such as, likewise the first mounting bracket 16A described above, a plurality of mounting holes or lateral recesses 76, for rigidly fixing the mounting bracket 16B against a mounting surface portion of a support structure using preferably flat-head screws, nails, or the like.

Also likewise the first mounting bracket 16A described above, the second mounting bracket 16B is provided with a cylindrically-shaped mounting member 92 having a C-shaped cross-section, and which has a longitudinal side portion integrally formed and disposed along a front side surface 84 portion substantially proximal and parallel to the upper edge 88 of the mounting plate member 82.

Substantially centrally disposed proximal the lower edge 90 of the mounting plate member 82 there is provided a substantially triangular-shaped channel member 94 that is extending outwardly, relative to the front side surface 84, and slightly angularly toward the upper edge 88 of the plate member 82, as best illustrated in FIG. 18. The substantially triangular-shaped channel member 94 is suitably configured and shaped to support a downwardly facing, longitudinal side surfaces 32 or 34 of a light emitting element 12, when the latter is fixed substantially horizontally to a vertical support structure using the second mounting bracket 16B.

Thus, the second mounting bracket 16B may be used for rigidly fixing a light emitting element 12 to a mounting surface portion of a support structure such that the distal longitudinal surface 36 of the light emitting element 12 may be projecting light perpendicularly outwardly relative to the mounting surface portion. Typically, the second mounting bracket 16B is usable for mounting an elongated lighting emitting element 12 on a vertical surface for projecting light laterally distally relative thereto, with the substantially triangular-shaped channel member 94 supporting a longitudinal side surface 32 or 34.

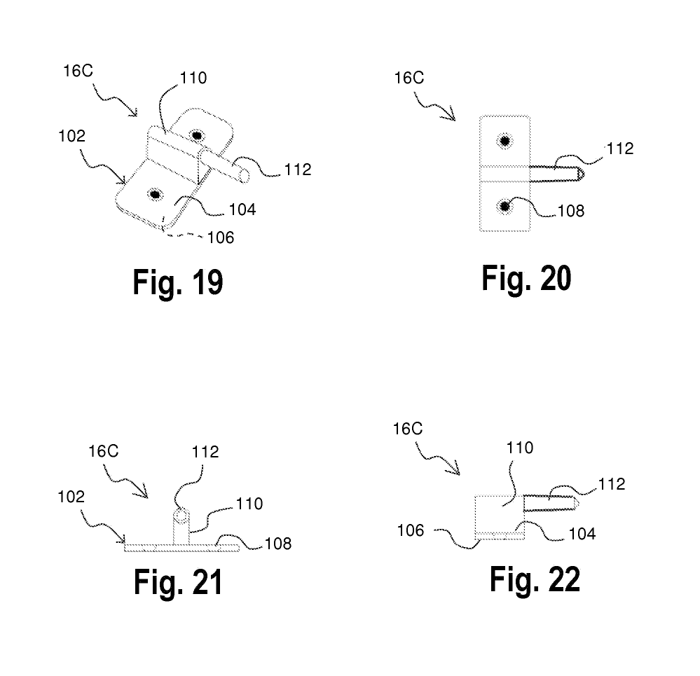

FIGS. 19 to 22 inclusively show various aspects of a third mounting bracket 16C. Referring to FIG. 19, the third mounting bracket 16C generally includes a substantially planar mounting plate member 102 defining a front side surface 104 and a rear side surface 106 adapted for abutting against a mounting surface portion of a support structure.

Mounting plate member 102 is further provided with suitable mounting means such as, likewise the first mounting bracket 16A described further above, a plurality of mounting holes 108 (as better seen in FIG. 21) or lateral recesses, for rigidly attaching the third mounting bracket 16C against a mounting surface portion of a support structure using for example flat-head screws, nails, or the like. Alternatively, double sided adhesive tape may be used between the rear side surface 106 and the mounting surface.

Third mounting bracket 16C further includes a pivot channel member 110 projecting substantially perpendicularly outwardly from the front side surface 104, and a pivot stud 112. Pivot stud 112, in turn, projects perpendicularly laterally from a distal end portion of the pivot channel member 110 in a substantially parallel configuration relative to the rear side surface 106.

The pivot stud 112 typically has a slightly tapered configuration towards the distal end thereof and with a base portion proximal the junction with the pivot channel member 110 that is having a cross-sectional diameter that is at least slightly greater than the mounting bracket engaging groove 40 of the elongated housing member 18. Thus, the pivot stud 112 is suitably sized and configured for longitudinally resiliently engaging one end of the mounting bracket engaging groove 40 such that an assembled light emitting element 12 may retain its rotational position about the pivot stud 112.

Typically, a pair of third mounting brackets 16C have their respective pivot stud 112 oppositely inwardly engaged within each distal ends of the mounting bracket engaging groove 40 of an assembled light emitting element 12, for resiliently supporting the latter at a user selected rotational angle relative to the third mounting brackets 16C. Furthermore, third mounting bracket 16C is typically configured and sized relative to an assembled light emitting element 12 such that the latter may be resiliently rotated about its longitudinal axis a full 360 degree thereabout without getting in contact with the mounting surface portion of a support structure on which are fixed the pair of third mounting brackets 16C.

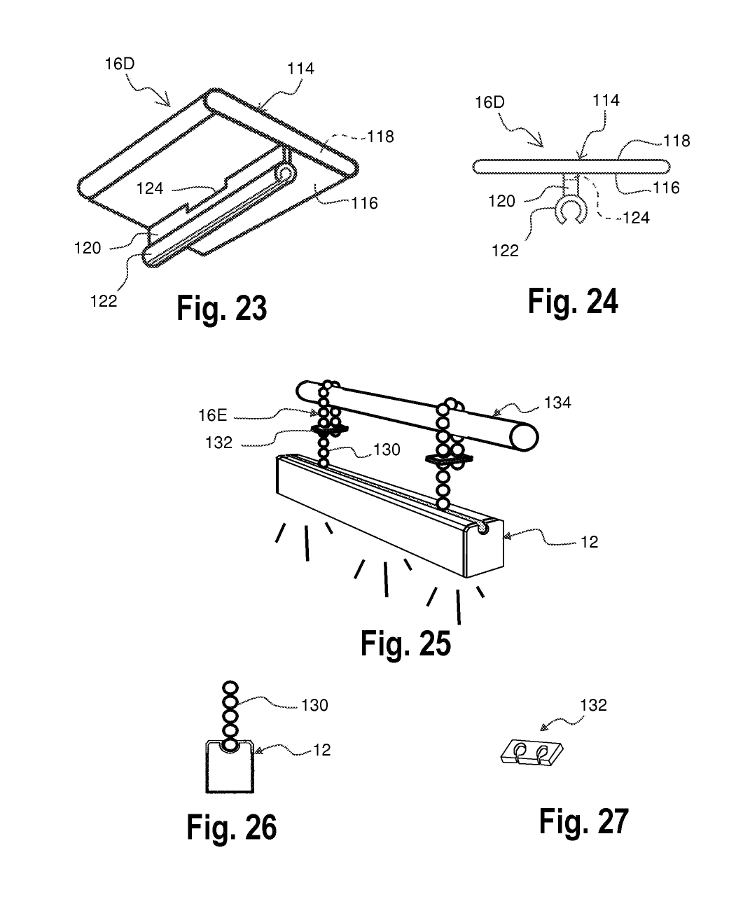

FIGS. 23 and 24 inclusively show various aspects of a fourth mounting bracket 16D. Fourth mounting bracket 16D generally includes a substantially planar mounting plate member 114 defining a front side surface 116 and a rear side surface 118 adapted for abutting against a mounting surface portion of a support structure.

Fourth mounting bracket 16D further generally includes an elongated ridge portion 120 protruding perpendicularly outwardly from, and extending linearly across, the front side surface 116 of mounting plate member 114. The distal longitudinal edge of the ridge portion 120 is terminated with an elongated and cylindrically-shaped mounting member 122 extending therealong, in a parallel configuration relative to the rear side surface 118. Likewise with the mounting member 80 of the first mounting bracket 16A, mounting member 122 has a C-shaped cross-section adapted for resiliently engaging the mounting bracket engaging groove 40 of an assembled light emitting element 12.

Furthermore, ridge portion 120 is provided with an attachment aperture 124 extending transversally therethrough, for example at a substantially centered position therealong. Attachment aperture 124 is usable, in cooperative relation with a conventional attachment means such as a string, a Tie-wrap, a snapper, a brooch, or the likes, for attaching the fourth mounting bracket 16D to an elongated channel member such as a curtain pole or the like.

FIGS. 25 to 27 inclusively show various aspects of a fifth mounting bracket 16E. Referring to FIG. 25, the fifth mounting bracket 16E generally includes a conventional ball chain element 130 and a ball chain locking member 132. Thus, with a distal end ball of the ball chain element 130 slidably inserted in the mounting bracket engaging groove 40 of the light emitting element 12, as illustrated in FIG. 26, and the opposite end of the ball chain element 130 passed over an horizontal channel member, such as a curtain rail 134, locked with a conventional ball chain locking member 132 including a pair of C-shaped apertures of a diameter smaller than that of the balls of the ball chain element 130, the valance light fixture 10 of the present invention may be conveniently suspended thereto.

The mounting brackets 16A to 16E are typically made of a suitably rigid material such as plastic using a conventional injection molding process, or metal using a conventional punch-press process.

FIG. 28 illustrates an alternate support housing 126 engaged on a distal end of a channel member 20. Alternate support housing 126 may be generally represented by a relatively short portion of the elongated housing member 18, as described further above. In other words, alternate support housing 126 is substantially identical in shape and configuration as the elongated housing member 18, complete with a mounting bracket engaging groove 40 (out of view in FIG. 28) and distal ends compatible with end caps 24 and 26, except that it is having a longitudinal length that is sized to cover only a relatively short distal end portion of a channel member 20.

Typically, a pair of alternate support housings 126, in cooperative relation with one or more of user selected support mounting brackets 16A to 16E described above may be used to support each distal ends of an elongated channel member 20.

Typically, an elongated light emitting element 12 may be fixed to a support structure by, first, rigidly fixing thereto at a suitable location at least one, but typically more than one of the mounting brackets 16A or 16B, using conventional fastening elements such as flat-head screws, double sided adhesive tape, glue, or the likes. Second, the mounting surface 30 of the light emitting element 12 is aligned such that the semi-circular mounting bracket engaging groove 40 is substantially aligned and abutting against the protruding portion of the mounting members 80 and/or 92 of the mounting brackets. Finally, as illustrated in FIGS. 1 and 3, the mounting bracket engaging groove 40 is engaged in a snap-fit relation onto the mounting members 80 and/or 92, by firmly pressing on the portions of the light emitting element 12 corresponding to the position of each mounting members. Alternatively, the mounting brackets 16C to 16E may be used as described hereinabove.

Thus there has been described a valance light fixture 10 having a light emitting element 12 that can be easily removed for maintenance or replacement, as well as being relatively easily customizable in terms of the direction and the color of the light that it is emitting toward its surrounding space. Furthermore, a plurality of valance light fixture 10 of the present invention can be easily connected in a daisy chain configuration.

FIG. 33 illustrates another embodiment of valance light fixture 200 that is similar in many aspects to the first embodiment of valance light fixture 10 described above.

Now referring to FIGS. 29A to 29C, the valance light fixture 200 includes a pair of distally opposed end support housings 260. Each end support housing 260 is represented by an open ended tubular member having a substantially square shaped cross-section and defining end support housing first and second ends 266 and 268 as better seen in FIGS. 29B and 29C.

End support housing 260 further defines a semi-circular support housing mounting groove 262 extending substantially centrally longitudinally along a top surface portion thereof, and at least one, but preferably more than one open ended support housing apertures 264 extending longitudinally inwardly relative to the end support housing second end 268. For example, support housing apertures 264 may extend along a wall member of the end support housing 260 that is opposite the one defining the support housing mounting groove 262, and one of the side wall relative thereof, with each one of the opposed end support housing 260 being a mirror image of the other one respectively.

The inner diameter of the end support housings 260 is suitably shaped and sized for slidably receiving therein, in a snug fit relation, an end portion of a channel member 220, which will be described further below.

Likewise the support housings 18 and 126 described further above, the end support housings 260 are each typically represented by a single piece element made of a suitably rigid plastic material that is either opaque, trans lucid, transparent, or a combination of these characteristics, using a conventional extruding or injection molding process.

Now referring to FIGS. 30A to 30C, the valance light fixture 200 further includes a pair of opposed and typically identically shaped housing member end caps 210. As seen for example in FIG. 30C, each one of the housing member end caps 210 is represented by an end cap plate member 218 that substantially conforms in shape and size to the end support housing first end 266, including an end cap outer surface 211 (better seen in FIG. 30B), an end cap inner surface 213, and an end cap mounting groove 214 along a top edge thereof. Each one of the housing member end caps 210 further includes an end cap base engaging member 215 extending perpendicularly from a lower edge portion of the end cap inner surface 213, and a pair of end cap top engaging member 217 extending perpendicularly parallelly from opposed upper corners of the end cap inner surface 213.

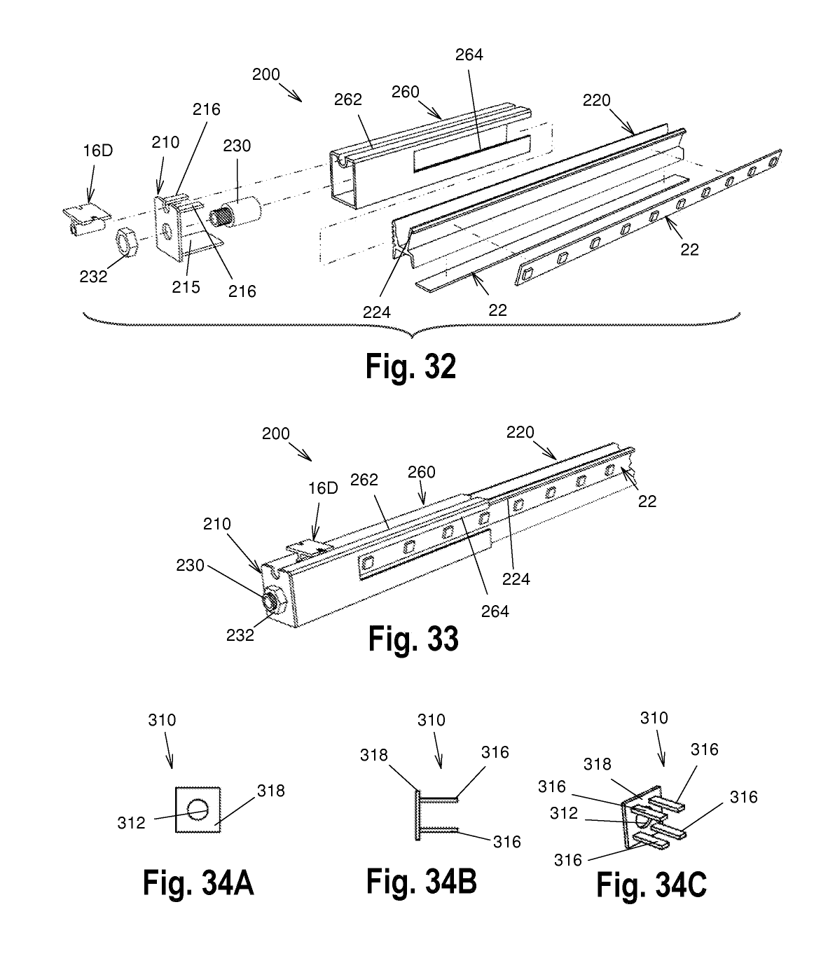

Each one of the housing member end caps 210 have their end cap top and bottom engaging members 215 and 217 suitably shaped and sized for longitudinally resiliently engaging inner surface portions along the whole width of the wall member opposite the support housing mounting groove 262, and the wall member portions on each side thereof respectively, as best illustrated in exploded view in FIG. 32.

Furthermore, each one of the housing member end caps 210 is provided with a substantially centered power connector aperture 212 for attaching therethrough a female power connector, which will be described further below.

The housing member end caps 210 may be made of the same material as the end support housing 260 described above.

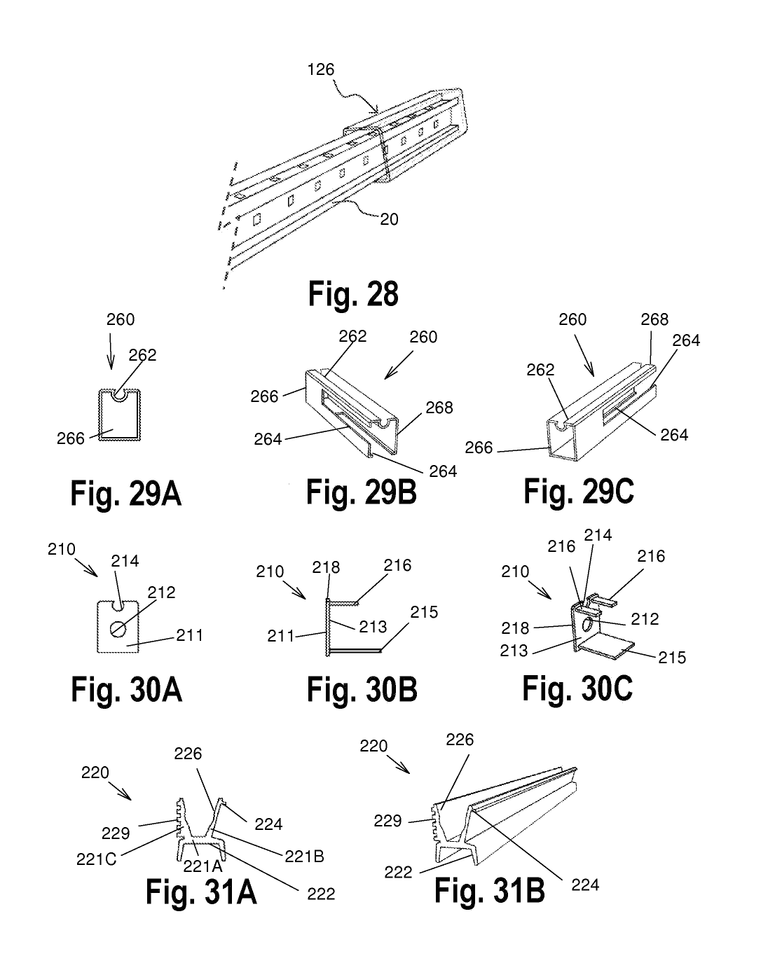

Now referring to FIGS. 31A and 31B, the valance light fixture 200 further includes a channel member 220. The channel member 220 is represented by a substantially elongated channel member defining a substantially U-shaped cross-section. Referring to FIG. 31A, the U-shaped cross-section of the channel member 220 generally defines a channel member bottom wall 221A, and spaced apart channel member lateral walls 221B and 221C extending therefrom.

A bottom light strip engaging groove 222 and a side light strip engaging groove 224 are extending longitudinally throughout the whole length, and extending laterally inwardly respectively, relative to the channel member bottom wall 221A and channel member lateral wall 221B respectively, of the U-shaped channel member 220.

The bottom and side light strip engaging grooves 222 and 224 are shaped and sized for longitudinally receiving therein an elongated light strip 22 as described further above. The light strip 22 may be attached within their respective groove using any conventional means such as suitable glue, transversally extending rivets or screws (not shown in the drawings). Furthermore, as is well known in the art of electronics, a layer of heat conductive substance may be applied along the inner surfaces of the grooves 222 and 224 before the light strips 22 are attached therein.

In some embodiments, the side light strip engaging groove 224 has its lower longitudinal portion that is preferably extending laterally inwardly a distance that is at least slightly greater than the relative inward depth of the upper longitudinal portion of the groove. Thus, the light strip 22 attached therein has its LEDs 54 projecting light at a slight downward angle relative to an imaginary horizontal plan.

The U-shaped cross-section of the channel member 220 further generally defines a plurality of heat sink fins 229 extending longitudinally along the outer surface of the channel member lateral wall 221C.

The U-shaped cross-section of the channel member 220 further generally defines a channel member top recess 226 extending longitudinally throughout the whole length and laterally downwardly between the spaced apart channel member lateral walls 221B and 221C. The channel member top recess 226 is shaped and sized for longitudinally receiving therein a multiconductor power cable (not shown in the drawings) used for powering the LED strips 22, as well as daisy-chaining electrical power to serially linked valance light fixtures 200, as it will be described in more details further below.

The channel member 220 is for example made of aluminum using a conventional extrusion process.

Now referring more particularly to FIG. 32, the valance light fixture 200 further includes a pair of standard female power connectors 230, only one of which is shown in FIG. 32, having their connector receiving end attached through the power connector aperture 212 of a respective one of the housing member end caps 210 using a suitable threaded nut 232. As would be obvious to someone familiar with the art, both female power connectors 230 are electrically coupled to the multiconductor electrical cable extending through the channel member 220 and light strips 22 in a conventional manner.

The valance light fixture 200 further typically includes a pair of mounting brackets engaged in the support housing mounting groove 262, such as mounting brackets 16A, 16B, 16C, 16D or 16E illustrated in FIGS. 14 to 27 inclusively, Mounting bracket 16D being shown in FIG. 33.

FIGS. 34A to 49 illustrate various aspects of yet another embodiment of valance light fixture forming a lighting system 300 that is substantially similar to the embodiments 10 and 200 described above. The lighting system 300 usable in the context of valence light fixtures, but also in any other context in which an assembly including LED strips and heat sinks must be manufactured. The whole lighting system 300 is illustrated in FIGS. 39 and 40, with the other figures from FIGS. 34A to 49 better illustrating various aspects of the lighting system 300.

Referring to FIG. 38, the lighting system 300 includes a substantially elongated and thermally conductive system body 320, a LED strip 22 and a a substantially elongated heat sink 370. In some embodiments, the lighting system 300 includes more than one LED strip 22, for example 2 LED strips 22, and more than one heat sink 370, for example an additional heat sink 360 that differs from the heat sink 370, or two or more heat sinks 370. The thermal conductivity of the system body 320 is sufficient to conduct heat from the LEDs 54 of the LED strip(s) 22 to the heat sink(s) 370 and 360 fast enough so that the LED strips 22 and LEDs 54 remain at an operational temperature. To that effect, the system body 320 is for example made of aluminum using a conventional extrusion process.

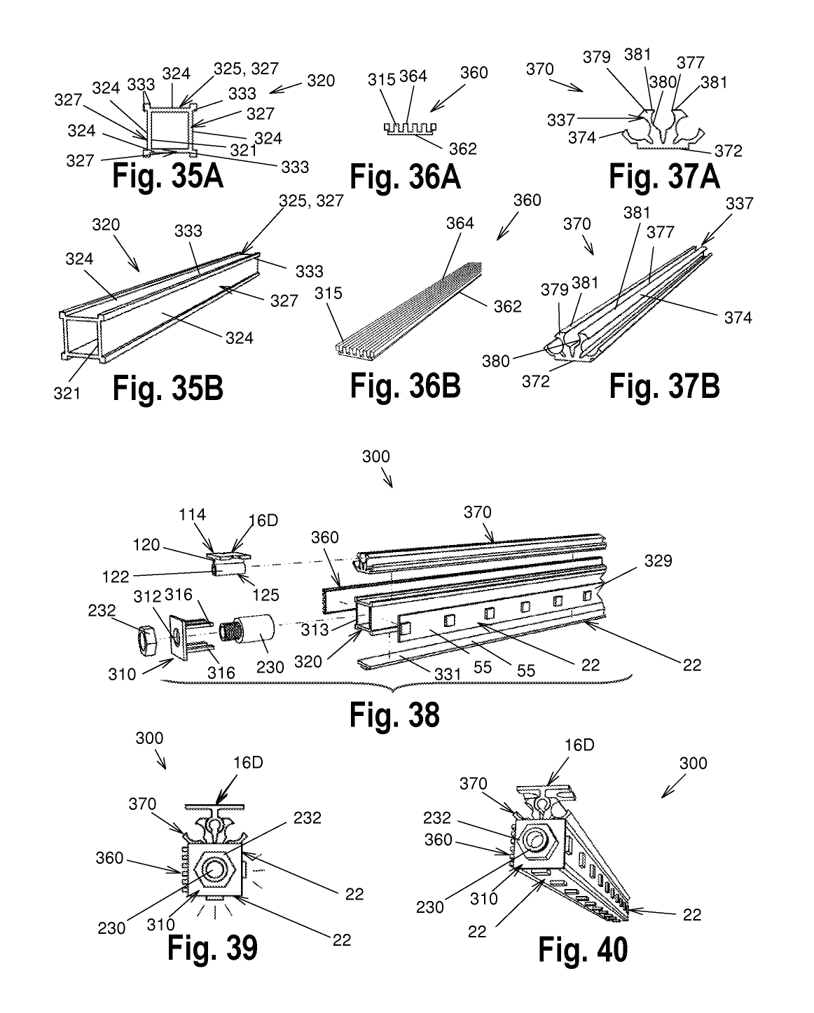

As better seen in FIG. 35B, the system body 320 defines a system body outer surface 325, the system body outer surface 325 defining at least two outer surface mounting sections 327, each of the at least two outer surface mounting sections 327 extending substantially longitudinally along the system body 320 at different circumferential locations therearound. For example, the system body 320 defines four outer surface mounting sections 327. The outer surface mounting sections 327 are typically substantially identically shaped and sized for longitudinally receiving and attaching thereto a LED strip 22 or a heat sink 360 or 370.

Typically, the system body 320 has a substantially polygonal transversal cross-sectional configuration with each side thereof forming one of the outer surface mounting sections 327, such as for example a substantially square transversal cross-sectional configuration as in the system body 320 illustrated in the drawings. However, other transversal cross-sectional configurations, such as a triangular, hexagonal, octagonal or circular configuration, among other possibilities are within the scope of the invention. Also, in some embodiments, some parts of the system body outer surface 325 do not define any outer surface mounting section 327. The system body 320 is typically hollow and as such defines a system body passageway 321 extending substantially longitudinally therethrough for receiving therethrough a multiconductor electrical cable (not shown in the drawings) used to power the LED strip(s) 22 in a conventional manner.

In some embodiments, the outer surface mounting sections 327 each define a respective recess 333 formed in the system body outer surface 325 and extending substantially longitudinally along the system body 320. However, in alternative embodiments, the recesses 333 are not present. The purpose of the outer surface mounting sections 327 is to allow mounting one of a heat sink 360 or 370 or a LED strip 22 thereto if desired. Each outer surface mounting section 327 is either purposed to receive a LED strip 22, or a plurality of LED strips 22 extending longitudinally from each other when shorter LED strips 22 are used, and one heat sink 360 or 370, or a plurality of heat sinks 360 or 370 extending longitudinally from each when shorter heat sinks 360 or 370 are used. Therefore, in other embodiments, the outer surface mounting sections 327 are shaped in any shape complementary to the shape of the heat sink 360 or 370 or a LED strip 22 to allow mounting thereto with good thermal transfer characteristics. Typically, the heat sinks 360 and 370 and the LED strips 22 are substantially snugly received in the recesses 333. Conveniently, the recesses 333, when present, facilitate assembly of the lighting system 300 when compared to completely flat surfaces.

Returning to FIG. 38, the LED strip 22 includes a substantially elongated strip body 55 defining strip body back and front surfaces 329 and 331 and a plurality of LEDs 54 mounted to the strip body front surface 331. Also, as seen respectively in FIGS. 36A and 37A for example, the heat sinks 360 and 370 define respectively a heat sink back surface 362 and 372 and a substantially opposed heat sink front surface 364 and 374.

The LED strip 22 and the heat sinks 360 and 370 are each alternatively mountable to any one of the outer surface mounting sections 327 with the strip body back surface 329 and the heat sink back surface 362 or 372 abutting against the outer surface mounting sections 327.

Referring to FIG. 35B, in embodiments in which the recess 333 is present, the recess 333 defines a recess bottom surface 324, the recess bottom surfaces 324 conforming to the strip body and heat sink back surfaces 329 and 362, 372. For example, the recess bottom surface 324, the strip body back surface 329 and the heat sink back surface 372 are each substantially planar, but other configurations, such as a curved configuration, are within the scope of the present invention. In a specific embodiment of the invention, each recess 333 has a substantially U-shaped tranversal cross-sectional configuration.

As mentioned hereinabove, there lighting system 300 includes for example two types of heat sinks 360 and 370. Now referring to FIGS. 36A and 36B, the first type of heat sink 360 is substantially elongated and rectangular in cross-section. The first type of heat sink 360 is suitably shaped and sized for longitudinally engaging one of the recesses 333. In other words, first type of heat sink 360 has a rear portion that is substantially identically shaped and sized to the rear portion of the LED strip 22. The first type of heat sink 360 has heat sink front surface 364 that defines a plurality of longitudinally and parallelly extending heat sink fins 315.

Now referring to FIGS. 37A and 37B, the lighting system 300 may further include one or more second type of heat sink 370, which is also substantially elongated, but which is for example generally half-circular in cross-section. As in the first type of heat sink 360, the second type of heat sink 370 has a rear portion that is substantially identically shaped and sized to the rear portion of the LED strip 22. Also, the second type of heat sink is provided with at least two, but typically more than two, longitudinally and parallelly extending heat sink fins 379 defined in the heat sink front surface 374. Typically, the heat sink fins 379 extend in cross-section in a substantially fan-like configuration, as best illustrated in FIG. 37A.

Typically, the lighting system 300 further includes one or more mounting bracket(s), such as mounting bracket 16D described hereinabove. However, any other type of suitable mounting bracket is usable, such as, for example, mounting brackets 16A, 16B, 16C and 16E described hereinabove. One particularity of the lighting system 300 is that the heat sink 370 is usable to mount the lighting system 300 to adjacent surfaces, in addition to dissipating heat. Generally speaking, the mounting bracket 16D defines a bracket coupling portion 125 (as shown in FIG. 38) and the heat sink 370 including at least one heat sink coupling portion 337 spaced apart from the heat sink back surface 362, as seen in FIGS. 37A and 37B. The heat sink and bracket coupling portions 337 and 125 are selectively couplable to each other to secure the heat sink 370 and the mounting bracket 16D to each other.

More particularly, the heat sink coupling portion 337 is defined by at least two adjacent heat sink fins 379 having their oppositely facing surfaces defining a mounting bracket engaging groove 380 therebetween for receiving thereinto the bracket coupling portion 125. Therefore, the heat sink coupling portion 337 defines at least one, and typically more than one, mounting bracket engaging groove 380 extending substantially longitudinally along the heat sink 370 and into the heat sink 370 from the heat sink front surface 374. In addition, the heat sink coupling portion 337 typically defines and a pair of groove lips 381 each extending partially across the mounting bracket engaging groove 380 substantially adjacent the heat sink front surface 374. The groove lips 381 define a substantially longitudinally extending groove gap 377 therebetween extending across the heat sink front surface 374.

Referring to FIG. 38, the bracket coupling portion 125 defines a groove engaging portion 122, referred to hereinabove as the mounting member 122, which is insertable in the mounting bracket engaging groove 380 and a neck 120, referred to hereinabove as the ridge portion 120, extending from the groove engaging portion 122 and positioned in the groove gap 377 when the mounting bracket 16D is operatively mounted to the heat sink 370 with the groove engaging portion 122 inserted in the mounting bracket engaging groove 380.

The mounting bracket engaging grooves 380 are for example substantially C-shaped in transversal cross-section and shaped and sized for slidably receiving therein the mounting member 122, typically substantially snugly, of the corresponding structures of any one of the mounting brackets 16A, 16B, 16C, or 16E illustrated in FIGS. 14 to 27. Similarly to the valence light fixture 10, the groove engaging portion 122 is typically substantially resiliently deformable so that the groove engaging portion 122 is deformed when compared to an undeformed configuration when operatively mounted to the heat sink 370 with the groove engaging portion 122 inserted in the mounting bracket engaging groove 380. For example this is achieved with a substantially C-shaped groove engaging portion 122 that opens substantially opposed the neck 120.

First and second types of heat sink 360 and 370 may be attached to the system body 320 in a similar manner as a LED strip 22 using a heat-conducting glue, and/or using fasteners, such as rivets, screws or the like, in combination with a heat conducting substance applied therebetween. Furthermore, first and second types of heat sink 360 and 370 are typically made of aluminum using a conventional extrusion process.

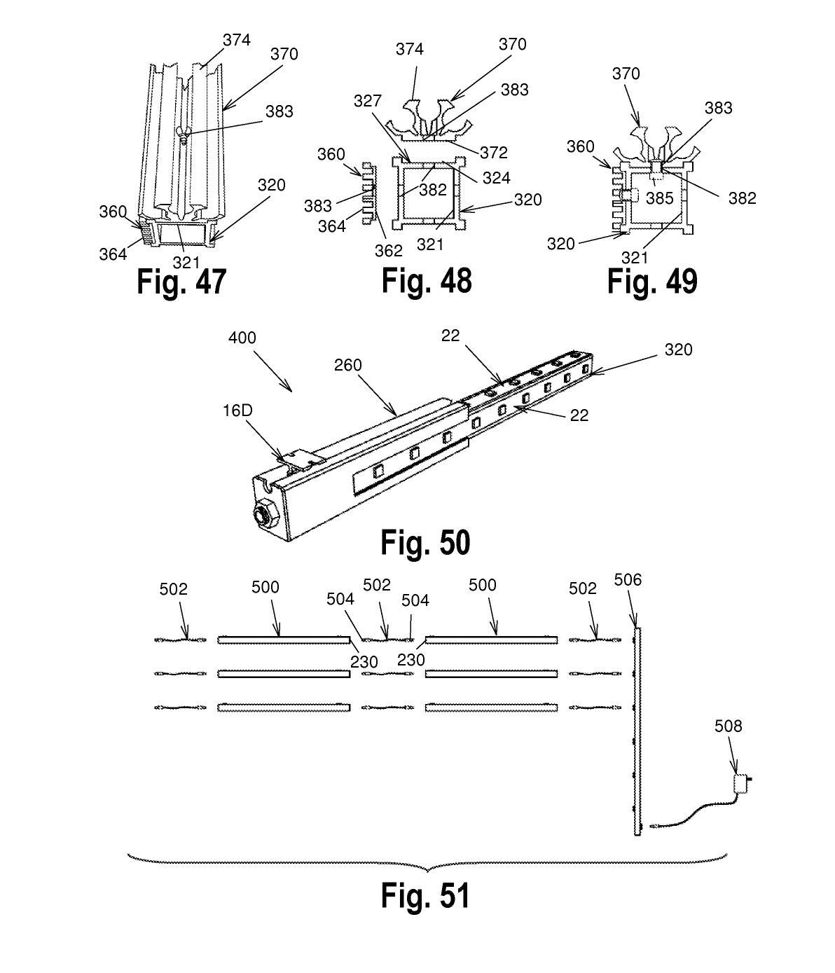

As exemplified in FIGS. 47, 48 and 49, the first and second types of heat sink 360 and 370 may be attached into selected recesses 333 using rivets 385 (seen in FIG. 49 only).

More specifically, as seen more clearly in FIG. 48, the heat sink 360, 370 may be provided with a series of heat sink bores 383 (only one of which is visible in FIGS. 47 to 49) extending between the heat sink front and back surfaces 362,372 and 364,374 and longitudinally spaced apart from each other, and the system body 320 is provided with a series of system body bores 382 extending between at least one of the outer surface mounting sections 327 and the system body passageway 321, and typically between each of the outer surface mounting sections 327 and the system body passageway 321. The heat sink bores 383 and system body bores 382 are pairwise in register with each other when the heat sink 360 and 370 is operatively mounted top the system body 320. A fastener, such as rivet 385, secures the heat sink 360, 370 to the system body 320 and extends through at least one of the system body bores 382 and through the heat sink bore 383 in register therewith.

Furthermore, selected corresponding pairs of system body bores 382 and heat sink bores 383 may be left open for providing cooling vent apertures for allowing heat accumulated inside the system body passageway 321 to dissipate therethrough.

Now referring to FIGS. 34A to 34C, and 38, the valance light fixture 300 typically further includes a pair of end caps 310. Referring to FIG. 34B for example, each one of the end caps 310 includes an end cap plate member 318 that is suitably sized and shaped for closing the square shaped system body passageway 321 at both system body ends 313 thereof (only one of which is shown in FIG. 38), an end cap central bore 312 extending centrally through the end cap plate member 318 (seen in FIGS. 34A, 34C and 38), for mounting therethrough the connector end of a female power connector 230 (as seen in FIG. 38), and end cap corner engaging members 316 extending parallelly from each corner of the inner side of the end cap plate member 318. Each end cap corner engaging members 316 is for resiliently engaging a corresponding corner end portion of the system body passageway 321.

Yet furthermore, as seen in FIGS. 45 and 46, the lighting system 300 may further include one or more heat sink-to-heat sink linking element 391. The heat sink-to-heat sink linking element 391, better seen in FIGS. 44A and 44B, defines a pair of substantially opposed linking element coupling portions 394 each selectively couplable to the heat sink coupling portion 337 of two different ones of the heat sinks 370 for securing the two different ones of the heat sinks 370 to each other. The linking element coupling portions 394 for example take the form of parallelly extending elongated elements having a substantially C-shaped transversal cross-sectional configuration, similar to the groove engaging portion 122 described hereinabove, linked to one another through a typically relatively short intermediate portion 395. The linking element coupling portions 394 are shaped and sized for resiliently longitudinally engaging the mounting bracket engaging grooves 380. Also, heat sink-to-heat sink linking element 391 includes two pairs of oppositely laterally extending stabilizing elements 396 extending from the intermediate portion 395 each adjacent one of the linking element coupling portion 394 and that are configured and sized for abutting against the heat sink front surface 374 when operatively mounted to the heat sink 370 so as to fix the orientation of the heat sink-to-heat sink linking element 391 relative to the heat sink 370 when operatively mounted thereto.

Heat sink-to-heat sink linking element 391 may be advantageously used for parallelly assembling two or more lighting systems 300 through oppositely facing second types of heat sink 370 attached to their respective system body 320, as seen in FIGS. 45 and 46. The stabilizing elements 396 are useful for fixing the relative angle between two, or more lighting systems 300 parallelly attached to one another. Heat sink-to-heat sink linking element 391 is typically relatively short and can be made of a suitably rigid polymeric material using a conventional extrusion or injection molding process.

FIGS. 42A and 42B, and FIGS. 43A and 43B illustrate alternative heat sink-to-heat sink linking element 390 and 392 respectively. The heat sink-to-heat sink linking element 391 is similar to the heat sink-to-heat sink linking element 390 except that the stabilizing elements 396 are omitted therefrom. Heat sink-to-heat sink linking element 392 is substantially similar to heat sink-to-heat sink linking element 391 except that its intermediate portion 389 is provided with an angle, for multiplying the possibilities of assembly between two or more lighting systems 300.

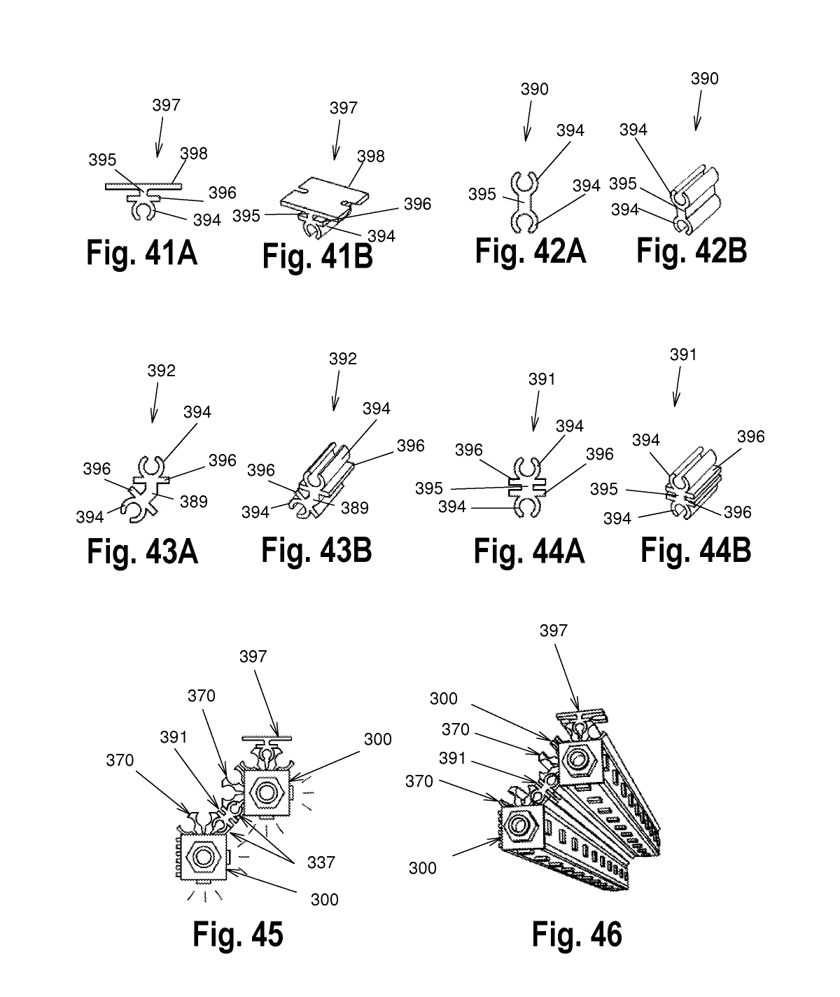

FIGS. 41A and 41B illustrate an alternative mounting bracket 397 similar to the heat sink-to-heat sink linking element 391, except that one of the linking element coupling portion 394 has been replaced with a mounting plate 398, for mounting the lighting system 300 to a support surface.

It is to be understood that the heat sink-to-heat sink linking elements 390, 391 and 392, and mounting bracket 397, are all compatible with any one of the mounting grooves of the other valance light fixture embodiments that have been described for the present invention.

FIG. 50 illustrates an alternate embodiment of a valance light fixture 400 that essentially represents an assembly of various components of the valance light fixture 200 and lighting system 300 described above. Namely, valance light fixture 400 includes all the components of the valance light fixture 200 except for the channel member 220 that has been replaced with the system body 320 of the lighting system 300. Furthermore, the four recesses 333 thereof are all occupied by low power LED strips 22.

FIG. 51 illustrates a parallel array assembly of valance light fixtures 500 serially powered in a daisy chain fashion using electrical link cables 502 provided with male electrical connectors 504 at each distal end thereof. The male electrical connectors 504 are compatible with the female electrical connectors 230 of the valance light fixtures 500. The array is energized in a conventional manner through an elongated power bar 506 and suitably sized power supply 508.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. A lighting system, said lighting system comprising:
a substantially elongated and thermally conductive system body, said system body defining a system body outer surface, said system body outer surface defining at least two outer surface mounting sections, each of said at least two outer surface mounting sections extending substantially longitudinally along said system body at different circumferential locations therearound;
a light emitting diode (LED) strip including a substantially elongated strip body defining strip body back and front surfaces and a plurality of LEDs mounted to said strip body front surface; and
a substantially elongated heat sink, said heat sink defining a heat sink back surface and a substantially opposed heat sink front surface;
wherein said LED strip and said heat sink are each alternatively mountable to any one of said at least two outer surface mounting sections with said strip body back surface and said heat sink back surface abutting against said outer surface mounting sections.

2. The lighting system as defined in claim 1, wherein said outer surface mounting sections each define a respective recess formed in said system body outer surface and extending substantially longitudinally along said system body.

3. The lighting system as defined in claim 2, wherein said recess defines a recess bottom surface, said recess bottom surfaces conforming to said strip body and heat sink back surfaces.

4. The lighting system as defined in claim 3, wherein said recess bottom surface, said strip body back surface and said heat sink back surface are each substantially planar.

5. The lighting system as defined in claim 2, wherein said recess has a substantially U-shaped tranversal cross-sectional configuration.

6. The lighting system as defined in claim 1, wherein said system body has a substantially polygonal transversal cross-sectional configuration.

7. The lighting system as defined in claim 6, wherein said system body has a substantially square transversal cross-sectional configuration.

8. The lighting system as defined in claim 1, wherein said system body outer surface defines at least three outer surface mounting sections, said at least two outer surface mounting sections being part of said at least three outer surface mounting sections, each of said at least three outer surface mounting sections extending substantially longitudinally along said system body at different circumferential locations therearound, said lighting system further comprising another LED strip mountable to any unoccupied one of said at least three outer surface mounting sections.

9. The lighting system as defined in claim 1, wherein said system body outer surface defines at least three outer surface mounting sections, said at least two outer surface mounting sections being part of said at least three outer surface mounting sections, each of said at least three outer surface mounting sections extending substantially longitudinally along said system body at different circumferential locations therearound, said lighting system further comprising another heat sink mountable to any unoccupied one of said at least three outer surface mounting sections.

10. The lighting system as defined in claim 1, wherein said system body is hollow and defines a system body passageway extending substantially longitudinally therethrough.

11. The lighting system as defined in claim 1, further comprising a mounting bracket, said mounting bracket defining a bracket coupling portion, said heat sink including at least one heat sink coupling portion spaced apart from said heat sink back surface, said heat sink and bracket coupling portions being selectively couplable to each other to secure said heat sink and said mounting bracket to each other.

12. The lighting system as defined in claim 11, wherein
said heat sink coupling portion defines a mounting bracket engaging groove extending substantially longitudinally along said heat sink and into said heat sink from said heat sink front surface, said heat sink coupling portion also defining and a pair of groove lips each extending partially across said mounting bracket engaging groove substantially adjacent said heat sink front surface, said groove lips defining a substantially longitudinally extending groove gap across said heat sink front surface; and
said bracket coupling portion defines a groove engaging portion insertable in said mounting bracket engaging groove and a neck extending from said groove engaging portion and positioned in said groove gap when said mounting bracket is operatively mounted to said heat sink with said groove engaging portion inserted in said mounting bracket engaging groove.

13. The lighting system as defined in claim 12, wherein said groove engaging portion is substantially snugly received in said mounting bracket engaging groove when said mounting bracket is operatively mounted to said heat sink with said groove engaging portion inserted in said mounting bracket engaging groove.

14. The lighting system as defined in claim 13, wherein said groove engaging portion is substantially resiliently deformable so that said groove engaging portion is deformed when compared to an undeformed configuration when operatively mounted to said heat sink with said groove engaging portion inserted in said mounting bracket engaging groove.

15. The lighting system as defined in claim 14, wherein said groove engaging portion is substantially C-shaped and opens substantially opposed said neck.

16. The lighting system as defined in claim 11, wherein
said heat sink coupling portion defines at least two substantially parallel mounting bracket engaging grooves each extending substantially longitudinally along said heat sink and into said heat sink from said heat sink front surface, said heat sink coupling portion also defining and a pair of groove lips for each of said mounting bracket engaging grooves, each of said groove lips extending partially across one of said mounting bracket engaging grooves substantially adjacent said heat sink front surface, said pairs groove lips each defining a substantially longitudinally extending groove gap across said heat sink front surface in register with a respective one of said mounting bracket engaging grooves; and
said bracket coupling portion defines a groove engaging portion selectively insertable in any one of said mounting bracket engaging grooves and a neck extending from said groove engaging portion and positioned in said groove gap in register with said one of said mounting bracket engaging grooves when said mounting bracket is operatively mounted to said heat sink with said groove engaging portion inserted in said one of said mounting bracket engaging grooves.

17. The lighting system as defined in claim 11, further comprising a heat sink-to-heat sink linking element, said heat sink-to-heat sink linking element defining a pair of substantially opposed linking element coupling portions each selectively couplable to said heat sink coupling portion of two different ones of said heat sinks for securing said two different ones of said heat sinks to each other.

18. The lighting system as defined in claim 17 wherein said heat sink-to-heat sink linking element includes a least one pair of stabilizing elements configured and sized for both abutting against said heat sink front surface when operatively mounted to said heat sink so as to fix an orientation of said heat sink-to-heat sink linking element relative to said heat sink when operatively mounted thereto.

19. The lighting system as defined in claim 10, wherein said heat sink is provided with a series of heat sink bores extending between said heat sink front and back surfaces and longitudinally spaced apart from each other and said system body is provided with a series of system body bores extending between at least one of said outer surface mounting sections and said system body passageway, said system body and heat sink bores being pairwise in register with each other when said heat sink is operatively mounted top said system body, said lighting system further comprising at least one fastener securing said heat sink to said system body and extending through at least one of said system body bores and through said heat sink bore in register with said at least one of said system body bores.

20. The lighting system as defined in claim 1, wherein said system body defines system body ends substantially longitudinally opposed to each other, said lighting system further comprising a pair of end caps mountable to said system body substantially adjacent said system body ends.

21. The lighting system as defined in claim 1, wherein said heat sink front surface defines heat dissipating fins, said heat sink coupling portion being formed by said heat dissipating fins.

22. The lighting system as defined in claim 1, wherein said outer surface mounting sections are substantially identically shaped and sized.
